(19) United States
(12) Patent Application Publication
(10) Pub. No.: US 2002/0044747 A1
(43) Pub. Date: Apr. 18, 2002

(54) Non-reciprocal phase shifter

(76) Inventors: Henry Hung, Paradise Valley, AZ (US); Yallapu Anjan, Scottsdale, AZ (US)

Correspondence Address: Donald J. Lenkszus, P.O. Box 3064, Carefree, AZ, 85377-3064, US

(21) Appl. No.: 09/811,976

(22) Filed: Mar. 19, 2001

Related U.S. Application Data
(60) Provisional application No. 60/240,623, filed on Oct. 16, 2000.

(51) Int. Cl. G02B 6/38

(52) U.S. Cl. 385/60

(57) ABSTRACT

A non-reciprocal phase shifter utilizes first and second Faraday crystals. A permanent magnet is disposed proximate the first Faraday crystal and a changeable magnetic source is disposed proximate the second Faraday crystal.

### FIELD OF THE INVENTION

This invention pertains to optical phase shifters, in general, and to optical non-reciprocal phase shifters, in particular.

### BACKGROUND OF THE INVENTION

A non-reciprocal phase shifter introduces a predetermined phase shift into an optical signal propagating in one direction and a different predetermined phase shift into an optical signal propagating in the opposite direction. In some instances, the magnitude of the phase shift in both directions is the same, but the shifts are of opposite sign.

Non-reciprocal phase shift is based on the principle of Faraday rotation. With Faraday rotation, the angle of rotation is defined as θ=νBl. B is the magnetic flux density, ν is the constant of proportionality known as the Verdet constant, and l is the length of the crystal. The Verdet constant is a measure of a crystal's ability to rotate the plane of polarization of optical signals. The direction of rotation depends on whether light propagation is parallel or anti-parallel to the magnetic flux density.

Applications of Faraday rotation include optical isolators and circulators. An optical isolator prevents or reduces the backward reflected light. A circulator directs light from one port to the next only one way. Both isolators and circulators are non-reciprocal devices. Most applications use 45 degree rotation, which is achieved by using bulk crystals such as Yttrium Iron Garnet (YIG) or thin film crystals such as Bismuth Iron Garnet (BIG). The thickness, l, of a crystal is selected to provide 45 degrees rotation in a saturating magnetic field.

Typical Faraday rotation of a crystal as a function of the magnetic field follows a hysteresis loop extending from −45 degrees to +45 degrees. With the crystal length, l, cut for 45 degrees rotation, the state of polarization is well defined when a saturating magnetic field is applied to the crystal in either direction. However, in a zero magnetic field, and at in between saturations, the rotation is not defined.

Optical non-reciprocal phase shifters are useful in a variety of applications including telecommunications and optical gyroscopes. It is highly desirable to provide a non-reciprocal phase shifter that is easy to manufacture, small in size and inexpensive.

### SUMMARY OF THE INVENTION

In accordance with the principles of the invention, a non-reciprocal optical phase shifter, comprises a first magneto-optic waveguide body of a material that, when subjected to magnetic fields, causes Faraday rotation effects on optical signal components and a second magneto-optic waveguide body of a material that, when subjected to magnetic fields causes Faraday rotation effects on optical signal components. A first waveguide is coupled to the first body. A second waveguide is coupled to the second body. A first magnetic field source is positioned proximate the first body. The magnetic field source subjects the first body to a first magnetic field such that said first body produces a first predetermined non-reciprocal optical phase shifts in optical signal components traversing the first body in opposite directions. A second magnetic field source is positioned proximate the second body, the second magnetic field source subjects the second body to a second magnetic field. The second magnetic field source is changeable to change the second magnetic field between first and second magnetic levels to provide a changeable non-reciprocal optical phase shift in optical signal components traversing the second body in opposite directions. The first body comprises a first Faraday rotator crystal and the second body comprises a second Faraday rotator crystal.

In accordance with one aspect of the invention, the second magnetic source is an electromagnet and a first permanent magnet comprises the first magnetic source.

In accordance with another aspect of the invention the second magnetic source comprises second and third permanent magnets. The second and third permanent magnets are movable relative to each other from a first relative position to a second relative position to provide the second magnetic field.

In accordance with yet another aspect of the invention an actuator moves the second and third magnets relative to each other.

Still further in accordance with the invention a method of providing non-reciprocal phase shifts in optical signals comprises: coupling optical signals to a first crystal that, when subjected to magnetic fields, causes Faraday rotation effects on optical signal components traversing said first crystal and optically coupling the first crystal to a second crystal that, when subjected to magnetic fields causes Faraday rotation effects on optical signal components traversing the second crystal. The method further includes providing a first magnetic field source proximate the first crystal, and utilizing the first magnetic field source to subject the first crystal to a first magnetic field such that the first crystal produces first predetermined non-reciprocal optical phase shifts in optical components traversing said first crystal in opposite directions. The method includes providing a second magnetic field source proximate the second crystal and utilizing the second magnetic field source to subject the second crystal to a second magnetic field changeable between first and second magnetic levels to provide a changeable non-reciprocal optical phase shift in optical signal components traversing the second crystal in opposite directions.

In accordance with the principles of the invention a non-reciprocal phase shift of 0 to 90 degrees is provided by establishing one Faraday rotating crystal to provide a rotation fixed at +45 or −45 degrees and utilizing a second Faraday rotating crystal that is switched between +45 and −45 degrees rotation to produce a net rotation of 0 to 90 degrees or vice versa.

### BRIEF DESCRIPTION OF THE DRAWING

The invention will be better understood from a reading of the following detailed description in conjunction with the drawing figures in which like reference numerals are used to designate like elements, and in which:

FIG. 1 is a cross-section of a non-reciprocal phase shifter in accordance with the invention; and

FIG. 2 is a cross-section of a second non-reciprocal phase shifter in accordance with the invention.

### DETAILED DESCRIPTION

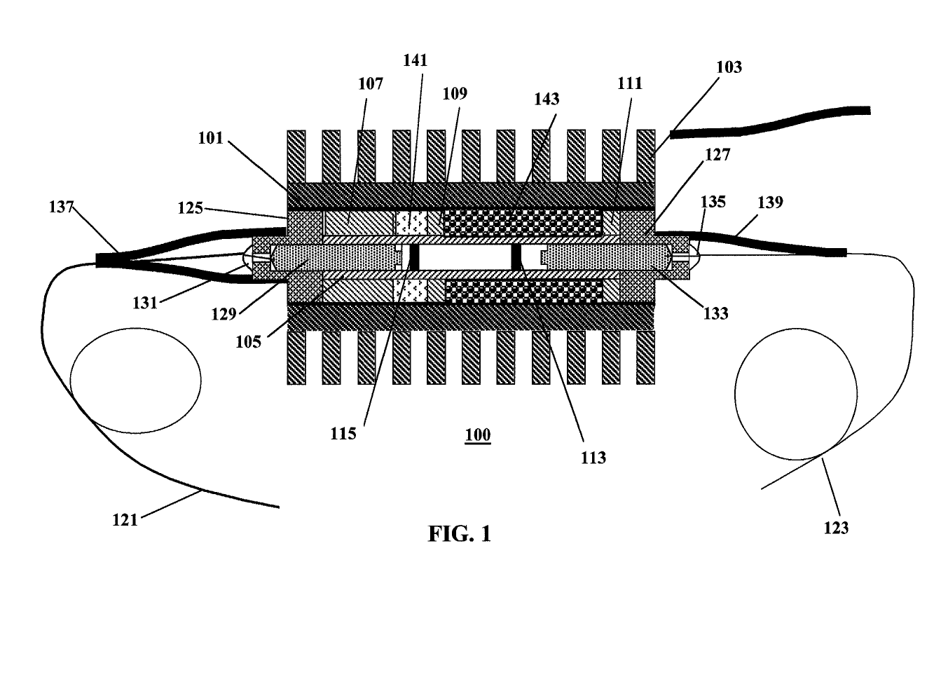

FIG. 1 illustrates a first embodiment of a non-reciprocal phase shifter (NRPS) 100 in accordance with the invention. NRPS 100 is a hermetically sealed unit that includes tubular aluminum housing 101 that has a plurality of heat radiating fms 103 disposed on its outer surface. An inner support sleeve or tube 105 is positioned concentric with housing 101. Tube 105 is also of aluminum in the illustrative embodiment. Support washers 107, 109, 111, support tube 105 within housing 101. Disposed within tube 105 are two magneto-optic Faraday rotation devices that are thin film BIG crystals 113, 115 Optical signals are coupled to and from the non-reciprocal phase shifter 100 via optical waveguides 121, 123, which in the particular embodiment shown are optical fiber. However, in other embodiments, one or both of the waveguides 121, 123 may be waveguides formed on a substrate and the non-reciprocal phase shifter may be formed on the substrate also as an integrated optic device. Optical fiber 121 extends through a housing cap washer 125 to couple to collimator 129. Epoxy 131 is used to bond fiber 121 in place. Similarly, optical fiber 123 extends through hosing cap washer 127 to couple to collimator 133. Epoxy 135 is used to bond fiber 123 in place. Boots 137, 139 are positioned on each housing cap washer 125, 127, respectively to support fibers 121, 123.

A ring shaped permanent magnet 141 is positioned concentric with BIG crystal 115. An electromagnet 143 is disposed proximate BIG crystal 113. Electromagnet 143 is formed by a wire coil.

In operation, crystal 115 is fixed at a predetermined rotation angle and crystal 113 is switched from a second predetermined rotation angle to a third predetermined rotation angle to provide for switching of NRPS 100. In the illustrative embodiment of the invention, permanent magnet 141 biases crystal 115 to either +45 degrees or −45 degrees of rotation. Electromagnet 143 switches its magnetic polarity to switch the Faraday rotation in crystal 113 between +45 degrees and −45 degrees. The combined result is that switching the magnetic polarity of electromagnet 143 produces a 0 to 90 degree phase shift.

The non-reciprocal phase shifter 100 of FIG. 1 is simply assembled, with construction similar to that of optical isolators. Advantageously, non-reciprocal phase shifter 100 provides low insertion loss of 1 dB or less, low cost and small size. More specifically the device of FIG. 1 is 48 mm in length and has an outside diameter of 10 mm without fins 103. With elliptical fins 103, the outside diameter is 28 mm×16 mm.

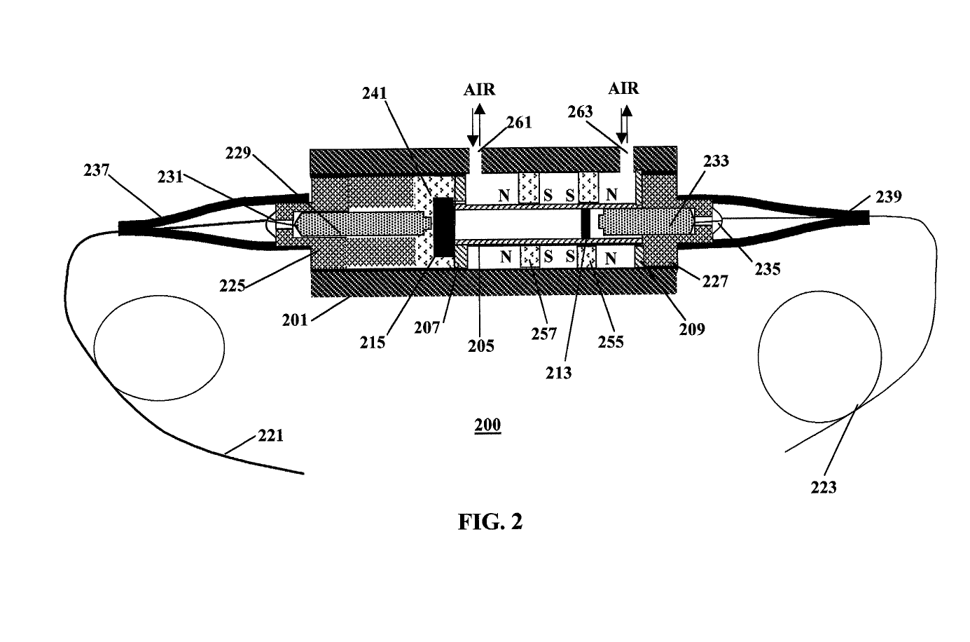

FIG. 2 illustrates a second non-reciprocal phase shifter 200 in accordance with the principles of the invention. Non-reciprocal phase shifter 200 differs in operation from non-reciprocal phase shifter 100 in that it utilizes a pair of permanent magnets in place of the electromagnet of the structure of FIG. 1.

NRPS 200 is a hermetically sealed unit that includes tubular aluminum housing 201. Because no heat generating components are included in NRPS 200, heat dissipating fins are not needed. An inner support sleeve or tube 205 is positioned concentric with housing 201. Tube 205 is also of aluminum in the illustrative embodiment. Support washers 107, 109 support tube 105 within housing 101. Disposed within tube 105 are two magneto-optic Faraday rotation device, i.e., thin film BIG crystals 213, 215. Crystal 215 is supported at one end of tube 205, and crystal 213 is disposed within tube 205. Optical signals are coupled to and from the non-reciprocal phase shifter 200 via optical waveguides 221, 223, which, in the particular embodiment shown, are optical fiber. In other embodiments, one or both of the waveguides 221, 223 may be waveguides formed on a substrate and the non-reciprocal phase shifter may be formed on the substrate also as an integrated optic device. Optical fiber 221 extends through a housing cap washer 225 to couple to collimator 229. Epoxy 231 is used to bond fiber 221 in place. Similarly, optical fiber 223 extends through housing cap washer 227 to couple to collimator 233. Epoxy 235 is used to bond fiber 223 in place. Boots 237, 239 are positioned on each housing cap washer 225, 227, respectively to support fibers 221, 223.

A ring shaped permanent magnet 241 is positioned concentric with crystal 215. A pair of ring shaped magnets 255, 257 are positioned on and longitudinally movable on tube 205. Magnets 255, 257 produce the same magnetic flux density, but are aligned to be of opposite magnetic polarity. Magnets 255,257 are movable from the position shown in FIG. 2 where magnet 255 is concentric with crystal 255 to a second position where Magnet 257 is concentric with crystal 213, and back to the first position. In the first position, magnet 255 causes crystal 213 to produce a predetermined Faraday rotation in one direction. In the second position, magnet 257 causes crystal 213 to produce a the predetermined Faraday rotation in the opposite direction. The advantage to this arrangement is that magnets 255, 257 may be moved by mechanical means such as pressurized air or vacuum in ports 261, 263 that are provided in housing 201. The magnetic positions are latching in both the first and second positions in that no continuous energy must be expended to maintain the magnets 255,257 in either the first or second position.

In operation, crystal 215 is fixed at a predetermined rotation angle and crystal 213 is switched from a second predetermined rotation angle to a third predetermined rotation angle to provide for switching of NRPS 200. In the illustrative embodiment of the invention, permanent magnet 241 biases crystal 115 to either +45 degrees or −45 degrees of rotation. Magnets 255, 257 are movable to switch the magnetic field at crystal 213 between two predetermined rotation angles of +45 degrees and -45 degrees. The combined result is that movement of magnets 255, 257 produces a phase shift that may, for example, be 0 or 90 degrees. Non-reciprocal phase shifter 200 is latchable in either state.

The non-reciprocal phase shifter 200 of FIG. 2 is also simply assembled, with construction similar to that of optical isolators. Advantageously, non-reciprocal phase shifter 200 provides low insertion loss of 1 dB or less, low cost and small size.

As will be appreciated by those skilled in the art, various modifications can be made to the embodiments shown in the various drawing figures and described above without departing from the spirit or scope of the invention. In addition, reference is made to various directions in the above description. It will be understood that the directional orientations are with reference to the particular drawing layout and are not intended to be limiting or restrictive. It is not intended that the invention be limited to the illustrative embodiments shown and described. It is intended that the invention be limited in scope only by the claims appended hereto.

What is claimed is:

1. A non-reciprocal optical phase shifter, comprising:
a first magneto-optic waveguide body of a material that, when subjected to magnetic fields, causes Faraday rotation effects on optical signal components;
a second magneto-optic waveguide body of a material that, when subjected to magnetic fields causes Faraday rotation effects on optical signal components;
a first waveguide coupled to said first body;
a second waveguide coupled to said second body;
a first magnetic field source proximate said first body, said magnetic field source subjecting said first body to a first magnetic field such that said first body produces a first predetermined non-reciprocal optical phase shifts in optical components traversing said first body in opposite directions;
a second magnetic field source proximate said second body, said second magnetic field source subjecting said second body to a second magnetic field, said second magnetic field source being changeable to change said second magnetic field between first and second magnetic levels to provide a changeable non-reciprocal optical phase shift in optical signal components traversing said second body in opposite directions.

2. A non-reciprocal optical phase shifter in accordance with claim 1, comprising:
a first collimator coupling said first waveguide to said first body; and
a second collimator coupling said second waveguide to said second body.

3. A non-reciprocal optical phase shifter in accordance with claim 1, wherein:
said first body comprises a first Faraday rotator crystal; and
said second body comprises a second Faraday rotator crystal.

4. A non-reciprocal optical phase shifter in accordance with claim 3, wherein:
said each of said first and second Faraday rotator crystals comprises a crystal of Bismuth Iron Garnet.

5. A non-reciprocal optical phase shifter in accordance with claim 4, wherein:
said first magnetic field source comprises a permanent magnet.

6. A nonreciprocal optical phase shifter in accordance with claim 5, wherein:
said second magnetic field source comprises an electromagnet.

7. A nonreciprocal optical phase shifter in accordance with claim 6, wherein:
said electromagnet is operable to change said second magnetic field between two levels.

8. A non-reciprocal optical phase shifter in accordance with claim 1, wherein:
said first and said second bodies each comprise Bismuth Iron Garnet.

9. A non-reciprocal phase shifter in accordance with claim 1, wherein:
said first magnetic field source comprises a permanent magnet.

10. A nonreciprocal optical phase shifter in accordance with claim 9, wherein:
said second magnetic field source comprises an electromagnet.

11. A nonreciprocal optical phase shifter in accordance with claim 10, wherein:
said electromagnet is operable to change said second magnetic field between two levels.

12. A non-reciprocal phase shifter in accordance with claim 1, wherein:
said first waveguide comprises optical fiber; and
said second waveguide comprises optical fiber.

13. A non-reciprocal phase shifter in accordance with claim 1, wherein:
said first and second waveguides are integrated onto a substrate.

14. A non-reciprocal phase shifter in accordance with claim 1, wherein:
said non-reciprocal phase shifts produced by said first and said second bodies combine to produce a total non-reciprocal phase shift at a first level for optical signals traversing said non-reciprocal phase shifter in a first direction and a total non-reciprocal phase shift at a second level for optical signals traversing said non-reciprocal phase shifter in a second direction.

15. A non-reciprocal phase shifter in accordance with claim 14, wherein:
said first level is zero degrees and said second level is 90 degrees.

16. A non-reciprocal phase shifter in accordance with claim 1, wherein:
said first body produces a non-reciprocal phase shift of 45 degrees; and
said second body produces a non-reciprocal phase shift of −45 degrees for said first magnetic level and a non-reciprocal phase shift of +45 degrees for said second magnetic level.

17. A non-reciprocal phase shifter in accordance with claim 1, wherein:
said first body produces a non-reciprocal phase shift of −45 degrees and
said second body produces a non-reciprocal phase shift of −45 degrees for said first magnetic level and a non-reciprocal phase shift of +45 degrees for said second magnetic level.

18. A non-reciprocal optical phase shifter, comprising:
a first crystal that, when subjected to magnetic fields, causes Faraday rotation effects on optical signal components traversing said first crystal;
a second crystal that, when subjected to magnetic fields causes Faraday rotation effects on optical signal components traversing said second crystal;
a first waveguide coupled to said first body,
a second waveguide coupled to said second body;
a first magnetic field source proximate said first crystal subjecting said first crystal to a first magnetic field such that said first crystal produces first predetermined non-reciprocal optical phase shifts in optical components traversing said first body in opposite directions;
a second magnetic field source proximate said second crystal, said second magnetic field source subjecting said second crystal to a second magnetic field changeable between first and second magnetic levels to provide a changeable non-reciprocal optical phase shift in optical signal components traversing said second crystal in opposite directions.

19. A non-reciprocal optical phase shifter in accordance with claim 18, comprising:
a first permanent magnet comprising said first magnetic source.

20. A non-reciprocal optical phase shifter in accordance with claim 18, comprising:
second and third permanent magnets comprising said second magnetic source.

21. A non-reciprocal optical phase shifter in accordance with claim 20, wherein:
said second and third permanent magnets are movable relative to each other from a first relative position to a second relative position to provide said second magnetic field.

22. A non-reciprocal optical phase shifter in accordance with claim 21, comprising:
an actuator for moving said second and third magnets relative to each other.

23. A method of providing non-reciprocal phase shifts in optical signals comprising:
coupling optical signals to a first crystal that, when subjected to magnetic fields, causes Faraday rotation effects on optical signal components traversing said first crystal;
optically coupling said first crystal to a second crystal that, when subjected to magnetic fields causes Faraday rotation effects on optical signal components traversing said second crystal;
providing a first magnetic field source proximate said first crystal;
utilizing said first magnetic field source to subject said first crystal to a first magnetic field such that said first crystal produces first predetermined non-reciprocal optical phase shifts in optical components traversing said first crystal in opposite directions;
providing a second magnetic field source proximate said second crystal; and
utilizing said second magnetic field source to subject said second crystal to a second magnetic field changeable between first and second magnetic levels to provide second crystal first and second non-reciprocal optical phase shift in optical signal components traversing said second crystal in opposite directions.

24. A method in accordance with claim 23, comprising:
utilizing an electromagnet as said second magnetic field source.

25. A method in accordance with claim 23, comprising:
utilizing permanent magnets movable relative to each other as said second magnetic source.

26. A method in accordance with claim 25, comprising:
moving said magnets relative to each other from a first relative position to a second relative position to change said second magnetic field from said first magnetic level to said second magnetic level.

27. A method in accordance with claim 26, comprising:
utilizing a first permanent magnet as said first magnetic source.

28. A method in accordance with claim 26, comprising:
providing mechanical means for moving said magnets relative to each other.

29. A method in accordance with claim 23, comprising:
selecting said first magnetic field to produce said first predetermined non-reciprocal phase shift at one of +45 degrees or −45 degrees; and
selecting said first and second magnetic levels to produce second crystal first and second non-reciprocal phase shifts of +45 and −45 degrees.
